(19) United States
(12) Patent Application Publication
(10) Pub. No.: US 2026/0244543 A1
(43) Pub. Date: Aug. 20, 2026

(54) Redundant Automation System and Method for Operating the Redundant Automation System

(71) Applicant: Siemens Aktiengesellschaft, Munchen (DE)

(72) Inventor: Jüergen LAFORSCH, Bühl (DE)

(21) Appl. No.: 19/162,472

(22) PCT Filed: Feb. 5, 2024
(86) PCT No.: PCT/EP2024/052681

§ 371 Date: Sep. 5, 2025

(30) Foreign Application Priority Data
Mar. 8, 2023 (EP) 23160779

(51) Int. Cl. G06F 11/20

(52) U.S. Cl. CPC G06F 11/2038; G06F 11/203

(57) ABSTRACT

A method for operating a redundant automation system which includes a first and second hardware units, wherein the first hardware unit includes a first and second processor units and the second hardware unit includes third and a fourth processor units, wherein the first hardware unit executes a first group of tasks via the first processor unit and executes a second group of tasks via the second processor unit, the second hardware unit executes a third group of tasks via the third processor unit and executes a fourth group of tasks via the fourth processor unit, where a time-offset comparison of the tasks of the first group and third group occurs via a first synchronization connection, and a highly synchronous comparison of the tasks of the second group and the fourth group occurs via the second synchronization connection.

### CROSS-REFERENCE TO RELATED APPLICATIONS

This is a U.S. national stage of application No. PCT/EP2024/052681 filed 5 Feb. 2024. Priority is claimed on European Application No. 23160779 filed 8 Mar. 2023, the content of which is incorporated herein by reference in its entirety.

### BACKGROUND OF THE INVENTION

### 1. Field of the Invention

The invention relates to a redundant automation system that comprises at least one first hardware unit and one second hardware unit, where the first hardware unit includes a first processor unit and a second processor unit, and the second hardware unit includes a third processor unit and a fourth processor unit, where the first hardware unit is configured to execute a first group of tasks via the first processor unit and to execute a second group of tasks via the second processor unit and to output corresponding output signals to an industrial process controlled by the redundant automation system, where the second hardware unit is configured to execute a third group of tasks via the third processor unit and to execute a fourth group of tasks via the fourth processor unit and to output corresponding output signals to an industrial process controlled by the redundant automation system or to receive the corresponding sensor signals from the industrial process, where the redundant automation system is configured to, in the event of failure of the first hardware unit, execute the tasks of the third group and the fourth group and to output the corresponding output signals to an industrial process controlled by the redundant automation system or to receive the corresponding sensor signals from the industrial process, and where the redundant automation system is configured to, in the event of failure of the second hardware unit, execute the tasks of the first and the second group and to output the corresponding output signals to the controlled industrial process, and where the redundant automation system includes a first synchronization connection, via which the tasks of the first group and the third group can be compared with one another, and includes a second synchronization connection, via which the tasks of the second group and the fourth group can be compared with one another.

Furthermore, the invention relates to a system that comprises a system for operating and monitoring the industrial process and a redundant automation system, and relates to a method for operating the redundant automation system.

### 2. Description of the Related Art

In the automation environment, there is an increasing demand for high-availability solutions (HA systems) that are suitable for reducing any downtime of the plant to a minimum. The development of such high-availability solutions is very costly, an HA system customarily used in the automation environment has two or more subsystems, formed as automation devices or computer systems, which are linked to one another via a synchronization connection. In principle, both subsystems can access the peripheral units connected to this HA system in read and/or write mode. One of the two subsystems is leading with regard to the peripherals connected to the system. The peripherals are connected in accordance with standardized communication protocols for redundant fieldbuses.

A redundant automation system comprising two subsystems, which is intended to increase the availability of a plant to be controlled, is known from the Siemens catalog ST 70, Chapter 6, 2011 edition. This automation system is synchronized regularly and it is ensured that the failure of one of these subsystems does not interfere with a process to be controlled because the other subsystem can continue the execution or processing of the corresponding part of their respective control program or the execution or processing of the corresponding parts of this control program.

EP 0 907 912 B1 discloses a conventional synchronization method for an automation system consisting of two subsystems. This synchronization method is based on a temporally synchronous coupling of the two subsystems, both subsystems waiting for a response from the other participant at suitable program points at which a comparison is intended and only then continuing their program processing in a temporally synchronous manner.

EP 2 657 797 A1 discloses a method for operating a redundant automation system that includes a particularly advantageous synchronization method.

EP 2 667 269 A1 also discloses an operating method for a redundant automation system.

Redundant automation systems generally pose the problem of processing incoming and outgoing data streams in a synchronized manner. This essentially means that incoming data streams on both redundant subsystems must be duplicated, and outgoing data streams generated in both redundant subsystems must be separated. This is associated with a correspondingly high computing time load on both subsystems in redundancy solutions known hitherto.

In automation systems, high-availability solutions (HA systems) are required in many cases. HA systems are characterized by the fact that the same automation task is executed redundantly on several different hardware units, but only the output signals from one of the hardware units are actually used to control the industrial process. This makes it possible for the other hardware unit to take control of the process without delay or at least virtually without delay in the event of failure of the hardware unit used to control the industrial process.

In order to be able to actually take control of the industrial process without delay or at least virtually without delay, firstly synchronization of the hardware units that perform the automation task in each case is required. It must be ensured that the hardware units work with the same data and process the same data in the same manner.

From the perspective of an operator station, conventional redundant automation systems use a high-availability connection to a communication partner, such as an operator station. If one transport connection fails, then it is possible to switch immediately to the other as the data repository in both modules of the automation system is compared via synchronization. This means, for example, that the request can be received via one sub-connection, but the acknowledgment can be returned via the other sub-connection of the high-availability connection. However, the comparison of the highly synchronous data repository required for this typically slows down throughput by a factor of 3.

### SUMMARY OF THE INVENTION

In view of the foregoing, it is therefore an object of the invention to provide a method for operating a redundant automation system and a corresponding redundant automation system that reduce resource expenditure caused by the automation system.

This and other objects and advantages are achieved in accordance with the invention by a automation system comprising at least one first hardware unit and at least one second hardware unit, the first hardware unit comprising a first processor unit and a second processor unit, and the second hardware unit comprising a third processor unit and a fourth processor unit, where the first hardware unit is configured to execute a first group of tasks via the first processor unit and a second group of tasks via the second processor unit and to output corresponding output signals to an industrial process controlled by the redundant automation system or to receive the corresponding sensor signals from the industrial process, where the second hardware unit is configured to execute a third group of tasks via the third processor unit and a fourth group of tasks via the fourth processor unit and to output corresponding output signals to an industrial process controlled by the redundant automation system or to receive the corresponding sensor signals from the industrial process, where the redundant automation system is configured to, in the event of failure of the first hardware unit, execute the tasks of the third group and the fourth group and to output the corresponding output signals to an industrial process controlled by the redundant automation system or to receive the corresponding sensor signals from the industrial process, and where the redundant automation system is configured to, in the event of failure of the second hardware unit, execute the tasks of the first and the second group and to output the corresponding output signals to the controlled industrial process or to receive the corresponding sensor signals from the industrial process, and where the redundant automation system comprises a first synchronization connection via which the tasks of the first group and the third group can be compared with one another and comprises a second synchronization connection via which the tasks of the second group and the fourth group can be compared with one another.

It is possible that the automation system has further hardware units each with two processor units, where the synchronization connections are configured in an analogous manner as explained before.

The respective hardware unit can be divided into two processor units, either in terms of hardware or software. The division therefore represents a “logical” division generally speaking.

The automation system in accordance with the invention is configured to enable redundant operation in a manner known per se, where it is possible for the two hardware units to each assume the tasks of the other hardware unit if the latter should be temporarily or permanently inoperable. For a comparison of the two hardware units, they are connected via a first and a second synchronization connection. The redundant configuration of the components of the automation system is intended to ensure continuous operation of the automation system, even in the event of a fault.

The automation system is characterized in accordance with the invention in that the first synchronization connection is established for a time-offset comparison of the tasks of the first group and the third group, and the second synchronization connection is established for a highly synchronous comparison of the tasks of the second group and the fourth group.

The first processor unit and third processor unit are preferably intended for communication tasks with external systems, such as an operator station. The first group of tasks and the third group of tasks are therefore preferably communication tasks that do not have any output signals to the controlled industrial process as a result.

The second processor unit and the fourth processor unit are preferably intended to execute tasks for controlling the industrial process and to output corresponding output signals to the industrial process controlled by the redundant automation system.

With the time-offset comparison of the tasks of the first and the third group between the first and third (communication) processor units, the resulting communication load can be significantly reduced compared to the prior art. The second and fourth (control) processor units are compared in a highly synchronous manner to achieve the necessary redundancy functionality.

The term “highly synchronous” means that the processing status of the second and fourth (control) processor unit is identical at all times to relatively low latency. In accordance with the invention, the highly synchronous comparison of the tasks of the second group and the fourth group via the second synchronization connection has a time lag of less than 1 millisecond. This means that the two processor units process the identical tasks with a delay/latency of less than 1 millisecond. The highly synchronous comparison of the second synchronization connection is advantageously initiated by the assignment of a new task to the second or the fourth group. Mention is made in this context of an event-synchronous coupling of the two second and fourth (control) processor units.

The two first and third (communication) processor units have a time lag of more than 10 milliseconds in the context of the time-offset comparison of the tasks. The comparison of the first and third (communication processor units) is not event-synchronous. Rather, the comparison can be delayed until there is also capacity for comparison on the synchronization connection.

In other words, the comparison between the first and third (communication) processor units within the scope of the invention is performed less frequently by orders of magnitude, preferably at least one order of magnitude less frequently, than the comparison/synchronization between the second and fourth (control) processor units. This significantly reduces the communication effort required by the automation system without, however, compromising the quality of the redundancy functionality. Another advantage of modeling is that it reduces the probability of both the first and third (communication) processor units switching simultaneously (in a quasi-synchronized manner) to the FAULT operating status; the availability of the first and third (communication) processor units increases.

In an advantageous embodiment of the invention, the first synchronization connection and the second synchronization connection use a common synchronization medium, in particular an optical waveguide. Such an optical waveguide is customary for the realization of a highly synchronous comparison and can also be used in a particularly advantageous manner for the non-highly synchronous (time-offset) comparison of the first and third (communication) processor units. This eliminates the need for an additional synchronization medium.

The objects and advantages are also achieved in accordance with the invention by a system comprising a system for operating and monitoring the industrial process and a redundant automation system, where the system for operating and monitoring the industrial process via a system bus, which in particular is formed as an Industrial Ethernet, is connected to the first processor unit of the first hardware unit, and the system for operating and monitoring the industrial process via the system bus being connected to the third processor unit of the second hardware unit, and where it is possible to connect the second processor unit of the first hardware unit and the fourth processor unit of the second hardware unit to the industrial process.

Preferably, only standardized connection methods are used for connection between the system for operating and monitoring (operator station). These standardized connection methods are characterized in that they do not have to be configured for high availability. Here, the system for operating and monitoring must establish two standard connections, one to the first and one to the third (communication) processor unit, in order to be able to switch to the other standard connection if need be in the event of a failure. The communication requests may have to be repeated. Particularly preferably, the system for operating and monitoring the industrial process is communicatively connected to the first processor unit and the third processor unit of the redundant automation system by means of a communication connection based on Transmission Control Protocol/Internet Protocol (TCP/IP) or Transport Layer Security (TLS).

The objects and advantages are also achieved in accordance with the invention by a method for operating a redundant automation system comprising at least one first hardware unit and one second hardware unit, where the first hardware unit includes a first processor unit and a second processor unit, and the second hardware unit includes a third processor unit and a fourth processor unit, where the first hardware unit is configured to execute a first group of tasks via the first processor unit and to execute a second group of tasks via the second processor unit, where the second hardware unit is configured to execute a third group of tasks via the third processor unit and to execute a fourth group of tasks via the fourth processor unit, where the redundant automation system is configured to, in the event of failure of the first hardware unit, execute the tasks of the third group and the fourth group and to output corresponding output signals to an industrial process controlled by the redundant automation system, and where the redundant automation system is configured to, in the event of failure of the second hardware unit, execute the tasks of the first and the second group and to output corresponding output signals to the controlled industrial process, and where the redundant automation system comprises a first synchronization connection via which the tasks of the first group and the third group can be compared with one another, and comprises a second synchronization connection via which the tasks of the second group and the fourth group can be compared with one another.

The method is characterized in that a time-offset comparison of the tasks of the first group and the third group occurs via the first synchronization connection, and a highly synchronous comparison of the tasks of the second group and the fourth group occurs via the second synchronization connection.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above described properties, features and advantages of this invention and the manner in which they are achieved will become clearer and easier to understand in connection with the following description of the exemplary embodiment, which is explained in more detail in connection with the drawing, in which:

FIG. 1 is a schematic illustration of the redundant automation system in accordance with the invention; and

FIG. 2 is a flowchart of the method in accordance with the invention.

### DETAILED DESCRIPTION OF THE EXEMPLARY EMBODIMENTS

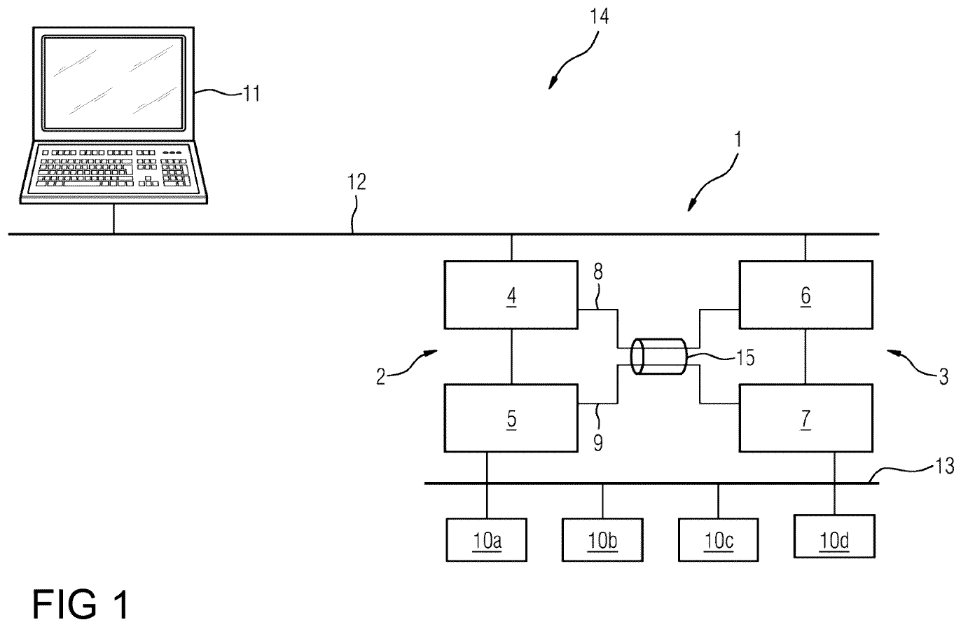

FIG. 1 shows a system 14 with an operator station server 11 as the system for operating and monitoring of an industrial process 10a, 10b, 10c, 10d and a redundant automation system 1. The automation system 1 has a first hardware unit 2 and a second hardware unit 3. The first hardware unit 2 comprises a first processor unit 4 and a second processor unit 5. The second hardware unit 3 comprises a third processor unit 6 and a fourth processor unit 7.

The first processor unit 4 of the first hardware unit 4 is connected to the operator station server 11 via a system bus 12 (an Industrial Ethernet). Likewise, the third processor unit 6 is connected to the operator station server 11 via the system bus 12. The second processor unit 5 and the fourth processor unit 7 are each connected to the industrial process 10a, 10b, 10c, 10d via a fieldbus 13. In addition, the first processor unit 4 and the second processor unit 5, and the third processor unit 6 and the fourth processor unit 7 are connected to one another.

The first processor unit 4 is connected to the third processor unit via a first synchronization connection 8. The second processor unit 5 is connected to the fourth processor unit 7 via a second synchronization connection 9. The two synchronization connections 8, 9 jointly use an optical waveguide 15 as a connection medium.

The first and third processor units 4, 6 function as communication processors that realize communication of the automation system 1 with the system for operating and monitoring 11. The second and fourth processor units 5, 7 server as control processors that control the industrial process 10a, 10b, 10c, 10d in a manner known per se.

Hereinafter, individual operating statuses of the processor units 4, 5, 6, 7 are explained with reference to individual operating phases of the automation system 1.

After activation of the automation system 1, the operating systems of the first and third (communication) processor units 4, 6, as well as of the second and fourth (control) processor units 5, 7 start running. Initially, the control processor units 5, 7 are in the operating status STOP.

The two communication processor units 4, 6 automatically perform a data comparison via the non-highly synchronous (time-offset) coupling of the first synchronization connection 8 as soon as the coupling is available. It is not necessary to wait until the first hardware unit 2 and the second hardware unit 3 are in a synchronized state, which was the case hitherto in known redundant automation systems.

Data synchronization relates to projected data (if already loaded) and to dynamic data, such as system diagnostics. This data synchronization occurs continuously, for example, when a project is loaded onto one of the communication processor units 4, 6.

Parallel to this data synchronization of machine states, new events that occur unilaterally on the communication processor units 4, 6 are exchanged via the non-highly synchronous (time-offset) coupling 8.

The system for operating and monitoring 11 thereupon starts the previously loaded user program in the first control processor unit 5, for example, via communication services using a standardized connection (for example, via TCP/IP) via the first communication processor unit 4. For this purpose, communication requests are executed in the first communication processor unit 4 or forwarded via an “Application Programming Interface” (API) to the second control processor unit 5 for read or write data access. The result is returned via the API of the first communication processor unit 4 and there a communication acknowledgment is generated. The acknowledgment is then returned to the system for operating and monitoring (operator station) 11 via the system bus 12.

The automation system 1 or the control processor unit 5 is then in the operating status RUN_SOLO. The control processor unit 7 is in the operating status STOP.

Another standardized connection with the identifier “M&C” ends at the third communication processor unit 6. All communication requests that contain the identifier “M&C” are forwarded to the first communication processor unit 4 as the fourth control processor unit 7 is in the operating status STOP.

If an event occurs on the second control processor unit 5, which is in the operating status RUN_SOLO (for example, because a limit value has been exceeded), then this event is made available via the API of the first communication processor unit 4.

The first communication processor unit 4 forwards the event to the third communication processor unit 6 via the non-highly synchronous (time-offset) coupling 8. The event is then processed locally in both communication processor units 4, 6 and, if necessary, the system for operating and monitoring (operator station) is informed via the standard connections of the communication processor units 4, 6.

It is now assumed that both communication processor units 4, 6 have completed the initial data synchronization. The second control processor unit 5 is in the operating status RUN_SOLO and the fourth control processor unit 7 is initially still in the operating status STOP.

The system for operating and monitoring (operator station) 11 triggers a synchronization method via communication via the first communication processor unit 4 for the control processor units 5, 7:
All standard connections to the third communication processor unit 6 are disconnected. This releases all state machines which were in use via these standard connections.
The data from the second control processor unit 5 is gradually transferred to the fourth control processor unit 7. This relates to administrative data and data from the user program, for example, contents of data modules. Once the transfer is complete, both control processor units 5, 7 switch to the operating status RUN_REDUNDANT.

From this point on, the standard connections to the third communication processor unit 6 can be reestablished and used again.

Hereinafter, it is assumed that the system for operating and monitoring (operator station) 11 sends a read or write request to the first communication processor unit 4. This communication processor unit makes the data available to its assigned second control processor unit 5. This second control processor unit 5 ensures the comparison of, for example, a request to write variables with the fourth control processor unit 7. The highly synchronous synchronization connection 9 between both control processor units 5, 7 is used for this purpose. Only when the request is available to both control processor units 5, 7 is it synchronized in processing in an event-synchronous manner, i.e., in chronological order with regard to other communication services. This synchronization guarantees an identical database on both control processor units 5, 7.

The results of the processing of the two control processor units 5, 7 are made available (in a highly synchronous manner) at the interfaces (APIs) in the direction of the first and third communication processor units 4, 6. As the original client, i.e., the first communication processor unit 4, is included in this information provided, only the corresponding first communication processor unit 4 is informed of the result, the event in the other API (here, the third communication processor unit 6) is discarded.

Communication-related processing thus only occurs in the first communication processor unit 4, which returns the acknowledgment to the system for operating and monitoring (operator station) 11 via the corresponding standard connection.

An important advantage of the present invention is that reading access can occur without highly synchronous coupling on the two control processor units 4, 6. As reading access represents a high proportion of communication services (typically, approximately 90%), a clear increase in performance can be achieved with a corresponding load distribution on the part of the system for operating and monitoring (operator station) 11 via the standard connections. In other words, in the present invention, only one of the two hardware units 2, 3 can be addressed in the context of a read operation by the system for operating and monitoring (operator station) 11 as the two communication processor units 4, 6 are not compared in a highly synchronous (time-offset) manner. It is sufficient for the system for operating and monitoring (operator station) 11 to address one of the two communication processor units 4, 6 for a read operation. This constitutes a significant advantage compared with known redundant automation systems.

If the system for operating and monitoring (operator station) 11 would like to read data that is only on the two communication processor units 4, 6, such as system diagnostics data, the corresponding request from the system for operating and monitoring (operator station) 11 can be processed without a data comparison and acknowledged by the respective communication processor unit 4, 6 to the system for operating and monitoring (operator station) 11.

The system for operating and monitoring (operator station) 11 can also write data that is to be stored on both communication processor units 4, 6. To do so, the first communication processor unit 4 sends the received request to the third communication processor unit 6 via the non-highly synchronous (time-offset) coupling 8. The data is then written on both communication processor units 4, 6. The acknowledgment from the third communication processor unit 6 is forwarded via the non-highly synchronous (time-offset) coupling 8 to the first communication processor unit 4 and discarded there.

The forwarded communication requests can be assigned suitable connection identifiers in order to be able to send the acknowledgment to the corresponding communication processor unit 4, 6. The data structures are designed in such a manner that they are identical on both communication processor units 4, 6.

Events on a communication processor unit 4, 6 always occur unilaterally. These are generally system diagnostics events, for example, because a wire break in a peripheral module has been detected and reported. This unilateral event on one communication processor unit 4, 6 is communicated to the other communication processor unit 4, 6 via the non-highly synchronous (time-offset) coupling 8. In this manner, the unilateral event can be processed locally and in real time by both communication processor units 4, 6. The duplicated event can be communicated to the system diagnostics as an alarm via all standard connections to the connected system for operating and monitoring (operator station) 11.

When the operating status switches from RUN_REDUNDANT to RUN_SOLO, the standard connections that end at the second hardware unit 3, for example, are terminated because the third control processor unit 6 switches to the operating status STOP. This prevents the system for operating and monitoring (operator station) 11 from processing data that no longer corresponds to the plant process. The standard connections can then be reestablished and used again. The disconnection can, for example, be limited to the standard connections with the identifier “M&C”. The system for operating and monitoring (operator station) 11 reestablishes these connections to the third communication processor unit 6. The communication services are forwarded via the non-highly synchronous (time-offset) coupling 8 to the first communication processor unit 4 for processing, provided that the fourth control processor unit 7 is in the operating status STOP. The other standard connections that do not have the identifier “M&C” could continue to run (for example, “engineering” connections).

The communication processor units 4, 6 and the control processor units 5, 7 can be combined (in pairs in each case) in a single assembly, for example, an industrial PC with a real-time operating system. However, it is also possible for the first (real) communication processor unit 4 to be assigned a second control processor unit 5, and for the fourth control processor unit 7 to be assigned a virtual third communication processor unit 6 which runs on a high-performance server as a virtual machine. In general terms, several virtual communication processor units 4, 6 that are assigned to several real control processor units 5, 7 can be instantiated on a high-performance computer. The real control processor units 5, 7 guarantee high availability of the user program processing with respect to the plant process.

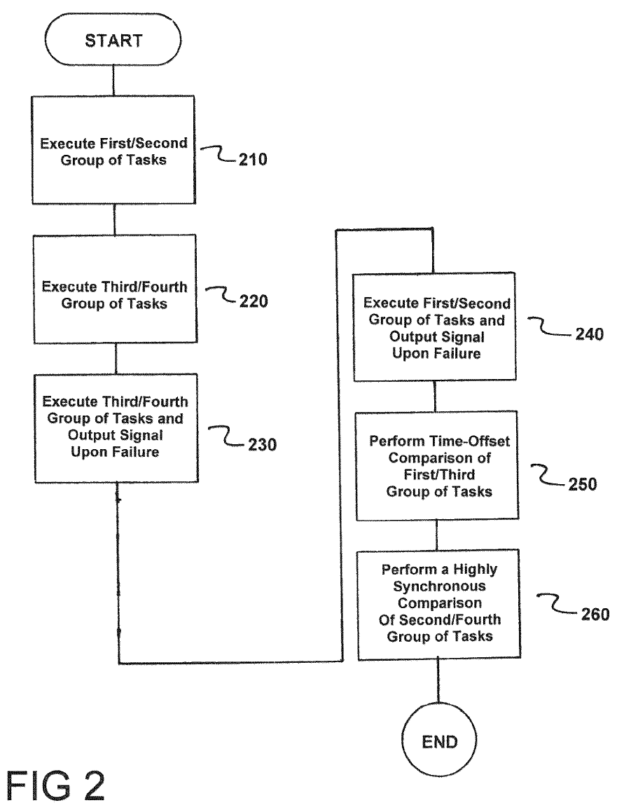

FIG. 2 is a flowchart of the method for operating a redundant automation system 1 comprising at least one first hardware unit 2 and at least one second hardware unit 3, where the first hardware unit 2 includes a first processor unit 4 and a second processor unit 5, and where the second hardware unit 3 includes a third processor unit 6 and a fourth processor unit 7.

The method comprises executing, by the first hardware unit 2, a first group of tasks via the first processor unit 4 and executing a second group of tasks via the second processor unit 5, as indicated in step 210.

Next, the second hardware unit 3 executes a third group of tasks via the third processor unit 6 and executes a fourth group of tasks via the fourth processor unit 7, as indicated in step 220.

Next, the redundant automation system 1, in the event of failure of the first hardware unit 2, executes the tasks of the third and fourth groups and outputs corresponding output signals to an industrial process 10a, 10b, 10c, 10d controlled by the redundant automation system 1, as indicated in step 230.

Next, the redundant automation system 1, in the event of failure of the second hardware unit 3, executes the tasks of the first and second groups and outputs corresponding output signals to the controlled industrial process 10a, 10b, 10c, 10d, as indicated in step 240. In accordance with the inventive method, the redundant automation system 1 comprises a first synchronization connection 8 via which the tasks of the first and third groups are compared with one another, and comprises a second synchronization connection 9 via which the tasks of the second and fourth groups are compared with one another.

Next, a time-offset comparison of the tasks of the first group and the third group is performed over the first synchronization connection 8, as indicated in step 250. Here, the time-offset comparison of the tasks of the first group and the third group via the first synchronization connection 8 has a time lag of more than 10 milliseconds.

Next, a highly synchronous comparison of the tasks of the second group and the fourth group is performed over the second synchronization connection 9, as indicated in step 260. Here, the highly synchronous comparison of the tasks of the second and the fourth groups via the second synchronization connection 9 has a time lag of less than 1 millisecond.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A redundant automation system comprising:
at least one first hardware unit including a first processor unit and a second processor unit; and
at least one second hardware unit including a third processor unit and a fourth processor unit;
wherein the first hardware unit is configured to execute a first group of tasks via the first processor unit, execute a second group of tasks via the second processor unit and output corresponding output signals to an industrial process controlled by the redundant automation system;
wherein the second hardware unit is configured to execute a third group of tasks via the third processor unit, execute a fourth group of tasks via the fourth processor unit and output corresponding output signals to an industrial process controlled by the redundant automation system,
wherein the redundant automation system is configured to, in an event of failure of the first hardware unit, execute the tasks of the third and fourth groups and output corresponding output signals to the industrial process controlled by the redundant automation system;
wherein the redundant automation system is further configured to, in an event of failure of the second hardware unit, execute the tasks of the first and second groups and output the corresponding output signals to the controlled industrial process;
wherein the redundant automation system further comprises:
a first synchronization connection via which the tasks of the first group and the third group are compared with one another; and
a second synchronization connection via which the tasks of the second group and the fourth group are compared with one another,
wherein the first synchronization connection is established for a time-offset comparison of the tasks of the first and third groups, the time-offset comparison of the tasks of the first group and the third group via the first synchronization connection having a time lag of more than 10 milliseconds; and
wherein the second synchronization connection is established for a highly synchronous comparison of the tasks of the second and fourth groups, the highly synchronous comparison of the tasks of the second and fourth groups via the second synchronization connection having a time lag of less than 1 millisecond.

13. The redundant automation system as claimed in claim 12, wherein the highly synchronous comparison is initiated by an assignment of a new task to the second or the fourth group.

14. The redundant automation system as claimed in claim 12, wherein the first synchronization connection and the second synchronization connection utilize a common synchronization medium.

15. The redundant automation system as claimed in claim 14, wherein the common synchronization medium comprises an optical waveguide.

16. The redundant automation system as claimed in claim 12, wherein the first and third group of tasks are essentially communication tasks which do not have any output signals to the controlled industrial process as a result.

17. A system which comprises a system for operating and monitoring the industrial process and the redundant automation system as claimed in claim 12;
wherein the system for operating and monitoring the industrial process is connected to the first processor unit of the first hardware unit via a system bus;
wherein the system for operating and monitoring the industrial process is connected via the system bus to the third processor unit of the second hardware unit; and
wherein the second processor unit of the first hardware unit and the fourth processor unit of the second hardware unit are connectable to the industrial process via a fieldbus.

18. The system as claimed in claim 17, wherein the system for operating and monitoring the industrial process is communicatively connected to the first processor unit and the third processor unit of the redundant automation system via a communication connection based on Transmission Control Protocol/Internet Protocol or Transport Layer Security.

19. The system as claimed in claim 17, wherein the system bus and the fieldbus are configured as Industrial Ethernets.

20. A method for operating a redundant automation system comprising at least one first hardware unit and at least one second hardware unit, the first hardware unit including a first processor unit and a second processor unit, and the second hardware unit including a third processor unit and a fourth processor unit, the method comprising:
executing, by the first hardware unit, a first group of tasks via the first processor unit and executing a second group of tasks via the second processor unit;
executing, by the second hardware unit, a third group of tasks via the third processor unit and executing a fourth group of tasks via the fourth processor unit;
executing, by the redundant automation system, in an event of failure of the first hardware unit, the tasks of the third and fourth groups and outputting corresponding output signals to an industrial process controlled by the redundant automation system;
executing, by the redundant automation system, in an event of failure of the second hardware unit, the tasks of the first and second groups and outputting corresponding output signals to the controlled industrial process, the redundant automation system comprising a first synchronization connection via which the tasks of the first and third groups are compared with one another, and comprising a second synchronization connection via which the tasks of the second and fourth groups are compared with one another;
performing a time-offset comparison of the tasks of the first group and the third group over the first synchronization connection, the time-offset comparison of the tasks of the first group and the third group via the first synchronization connection having a time lag of more than 10 milliseconds; and
performing a highly synchronous comparison of the tasks of the second group and the fourth group over the second synchronization connection, the highly synchronous comparison of the tasks of the second and the fourth groups via the second synchronization connection having a time lag of less than 1 millisecond.

21. The method as claimed in claim 20, wherein the highly synchronous comparison is initiated by assignment of a new task to the second or the fourth group.

22. The method as claimed in claim 20, wherein the first synchronization connection and the second synchronization connection utilizing a common synchronization medium comprising an optical waveguide.

23. The method as claimed in claim 9, wherein the first synchronization connection and the second synchronization connection utilizing a common synchronization medium comprising an optical waveguide.

24. The method as claimed in claim 8, wherein the first and third group of tasks are essentially communication tasks which do not have any output signals to the controlled industrial process as a result.

25. The method as claimed in claim 9, wherein the first and third group of tasks are essentially communication tasks which do not have any output signals to the controlled industrial process as a result.

26. The method as claimed in claim 10, wherein the first and third group of tasks are essentially communication tasks which do not have any output signals to the controlled industrial process as a result.
